(19) United States
(12) Patent Application Publication
(10) Pub. No.: US 2003/0188611 A1
(43) Pub. Date: Oct. 9, 2003

(54) Slitter Knife system

(76) Inventor: Gary I. Solberg, Hixson, TN (US)

Correspondence Address: Michael S. Neustel, Suite No. 4, 2534 South University Drive, Fargo, ND, 58103, US

(21) Appl. No.: 10/117,842

(22) Filed: Apr. 4, 2002

(51) Int. Cl. B26D 7/01

(52) U.S. Cl. 83/13; 83/954; 83/425; 83/481; 83/482; 83/499; 83/508.2

(57) ABSTRACT

A slitter knife system for facilitating efficient changing of cutting knives upon a slitting machine. The slitter knife system includes a main housing, a chuck housing movably positioned within the main housing, a plunger member movably positioned within the chuck housing, an arbor member rotatably attached about a portion of the chuck housing for receiving an upper knife, a clamp member positioned adjacent the upper knife, and an outer bearing attached to a distal portion of the plunger member. Utilizing a source of air pressure, a user is able to draw the plunger member inwardly so that the outer bearing forces the clamp member tightly against the upper knife. When replacement of the upper knife is required, the user releases the air pressure and a spring engaging the plunger member forces the same outwardly to allow for removal of the clamp member thereby providing unobstructed access to the upper knife.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to slitting machines and more specifically it relates to a slitter knife system for facilitating efficient changing of cutting knives upon a slitting machine.

2. Description of the Related Art

Slitter machines have been in use for years for cutting a continuous web of material into strips such as paper, polyethylene, polypropylene, polyester, film laminates, pressure sensitive label stock, extensible films, plastic, rubber, textile, film, metalized films, and various other flexible materials. Illustrations of patented slitter machines are disclosed within U.S. Pat. No. 5,083,489 to Tidland et al. and U.S. Pat. No. 6,253,652 to Dax et al. A manufacturer of slitting machines and other accessories is MAXCESS INTERNATIONAL which produces slitting machines under the brand name TIDLAND.

Conventional slitter machines are comprised of a circular upper knife (also called a “rotary shear knife” or “male knife”) that overlaps with a lower knife (also called the “female knife”) to provide a scissors-like action for cutting a continuous roll of material as the material is pulled between the upper knife and the lower knife. The upper knife is typically a non-powered rotary cutting disk rotatably attached within a carriage which is attached to a transverse bar member. The upper knife typically ranges from 2 inches to 24 inches in diameter depending upon the application. A plurality of carriages may be attached to the transverse bar member to create parallel strips of various widths. The lower knife may be a blade supported from underneath the roll or a roller/drum having a sharpened edge. The upper knife and the lower knife create a shearing action against the continuous material as it unwinds from a roll and is pulled through the slitter machine by a rewind or a take-up roll.

The upper knives of the slitter machine often times require replacement upon becoming damaged or dulled. The process of changing the upper knife can be time consuming and makes the slitter machine non-operational for extended periods of time which is extremely costly. FIGS. 11 and 12 of U.S. Pat. No. 5,083,489 provides an example of the structure that retains the upper knife (20) which requires the loosening of three bolts (154) and then the rotation of the retaining ring (138) to remove the upper knife from the carriage structure. There are various other upper knife changing systems that typically require the loosening or removal of a plurality of bolts from the carriage structure.

The main problem with conventional slitter machines is that it is time consuming to replace the upper knives after they have become damaged or worn. A further problem with conventional slitter machines is that they require the entire slitter machine to be non-operational for extended periods of time during the replacement of the upper knives which is costly to for the owner of the slitter machine.

While these devices may be suitable for the particular purpose to which they address, they are not as suitable for facilitating efficient changing of cutting knives upon a slitting machine. Conventional slitter machines do not provide for an efficient system for replacing the upper knives thereby costing the owner of the slitter machine significant amounts of time and money.

In these respects, the slitter knife system according to the present invention substantially departs from the conventional concepts and designs of the prior art, and in so doing provides an apparatus primarily developed for the purpose of facilitating efficient changing of cutting knives upon a slitting machine.

### BRIEF SUMMARY OF THE INVENTION

In view of the foregoing disadvantages inherent in the known types of slitter machines now present in the prior art, the present invention provides a new slitter knife system construction wherein the same can be utilized for facilitating efficient changing of cutting knives upon a slitting machine.

The general purpose of the present invention, which will be described subsequently in greater detail, is to provide a new slitter knife system that has many of the advantages of the slitter machines mentioned heretofore and many novel features that result in a new slitter knife system which is not anticipated, rendered obvious, suggested, or even implied by any of the prior art slitter machines, either alone or in any combination thereof.

To attain this, the present invention generally comprises a main housing, a chuck housing movably positioned within the main housing, a plunger member movably positioned within the chuck housing, an arbor member rotatably attached about a portion of the chuck housing for receiving an upper knife, a clamp member positioned adjacent the upper knife, and an outer bearing attached to a distal portion of the plunger member. Utilizing a source of air pressure, a user is able to draw the plunger member inwardly so that the outer bearing forces the clamp member tightly against the upper knife. When replacement of the upper knife is required, the user releases the air pressure and a spring engaging the plunger member forces the same outwardly to allow for removal of the clamp member thereby providing unobstructed access to the upper knife.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a slitter knife system that will overcome the shortcomings of the prior art devices.

A second object is to provide a slitter knife system for facilitating efficient changing of cutting knives upon a slitting machine.

Another object is to provide a slitter knife system that significantly reduces the amount of time to replace cutting knives upon a slitting machine.

An additional object is to provide a slitter knife system that may be utilized with various designs and structures of slitting machines.

A further object is to provide a slitter knife system that significantly reduces the amount of time the slitter machine is out of operation during the changing of the slitter knives.

Another object is to provide a slitter knife system that is cost effective to utilize within the slitter industry.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1a is an exploded upper perspective view of the main housing, plunger member and chuck housing.

FIG. 1b is an exploded upper perspective view of the main housing with the chuck housing and plunger member positioned within respect to the arbor member, upper knife and clamp member.

FIG. 2 is a side view of the present invention.

FIG. 3 is a front view of the present invention.

FIG. 4 is a top exploded view of the present invention.

FIG. 5 is a cross sectional view taken along line 5-5 of FIG. 2.

FIG. 6 is a cross sectional view taken along line 6-6 of FIG. 3 illustrating the clamp member tightly retaining the upper knife upon the arbor member.

FIG. 7 is a cross sectional view illustrating the plunger member being extended outwardly.

FIG. 8 is a cross sectional view illustrating the plunger member fully extended with the clamp member and the upper knife removed from the arbor member.

FIG. 9 is a front view illustrating the clamp member being removed from the arbor member.

### DETAILED DESCRIPTION OF THE INVENTION

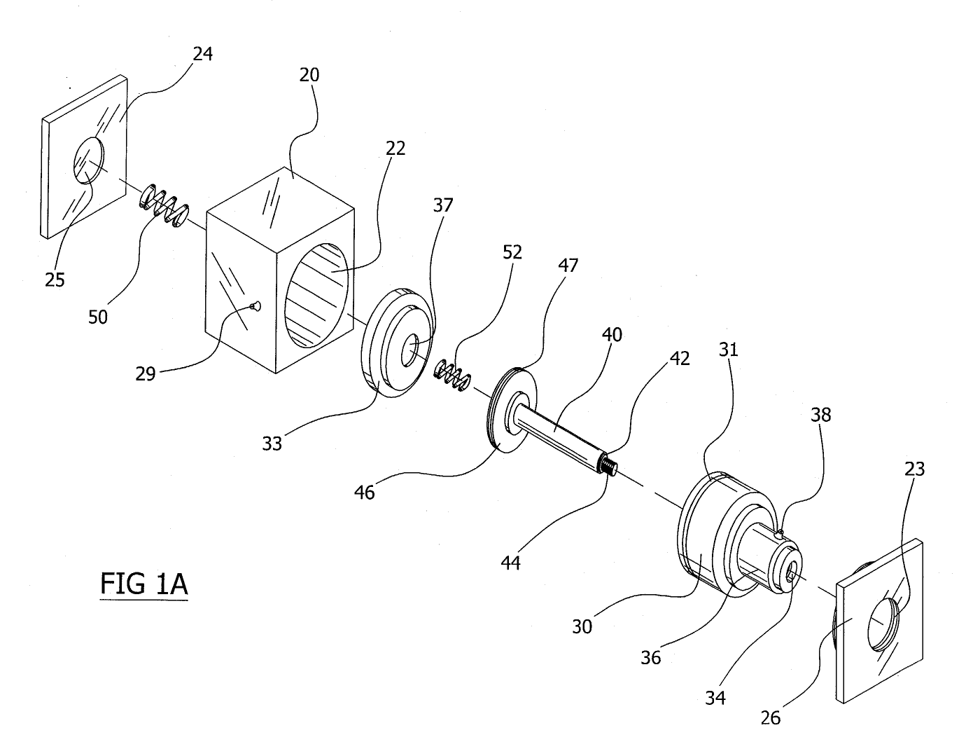

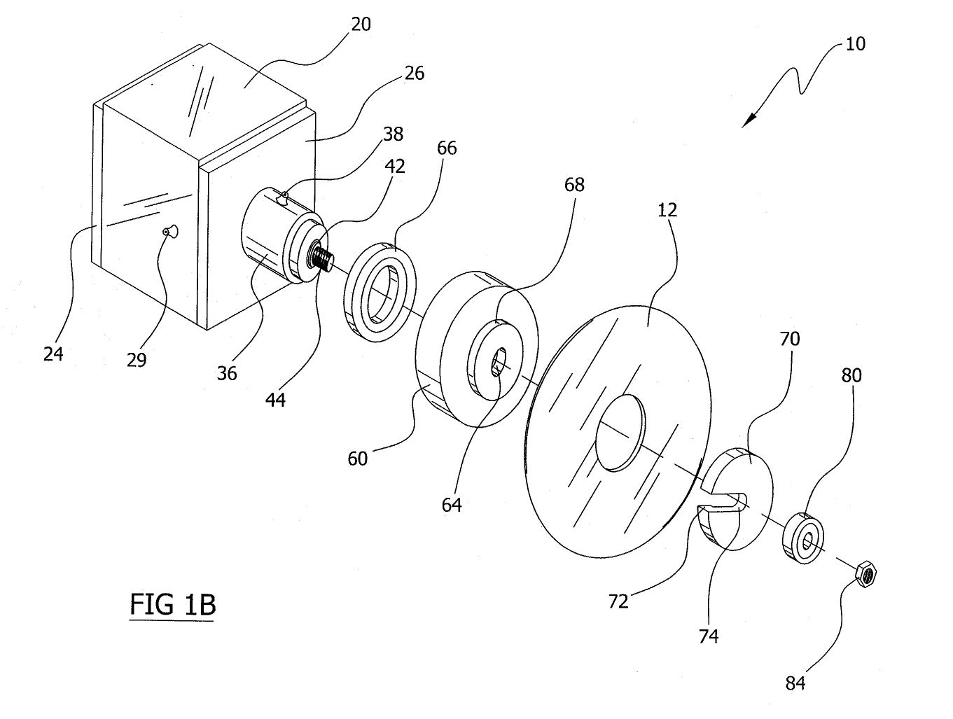

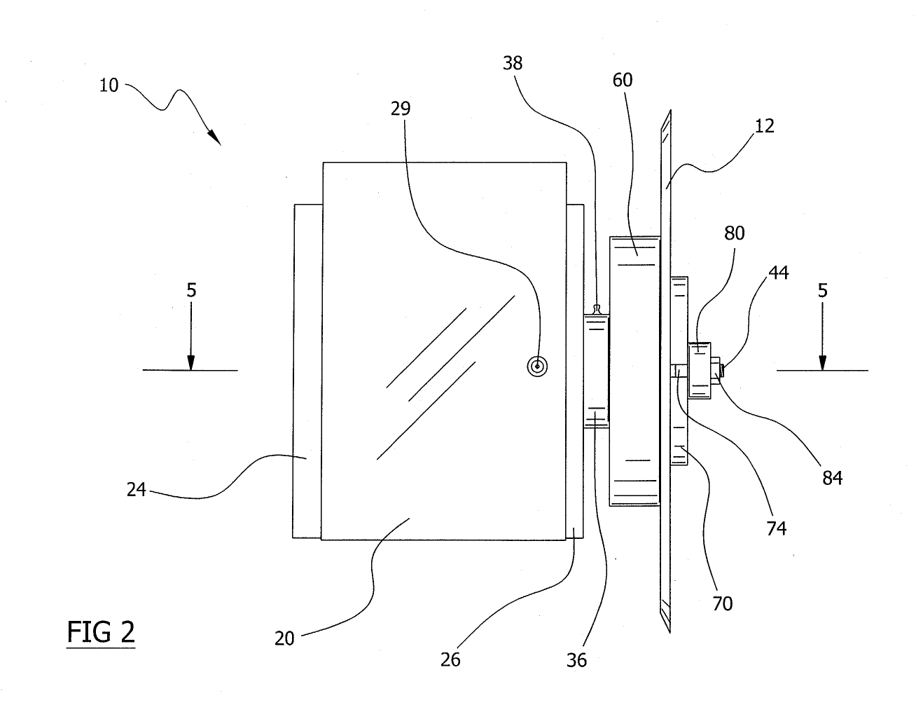

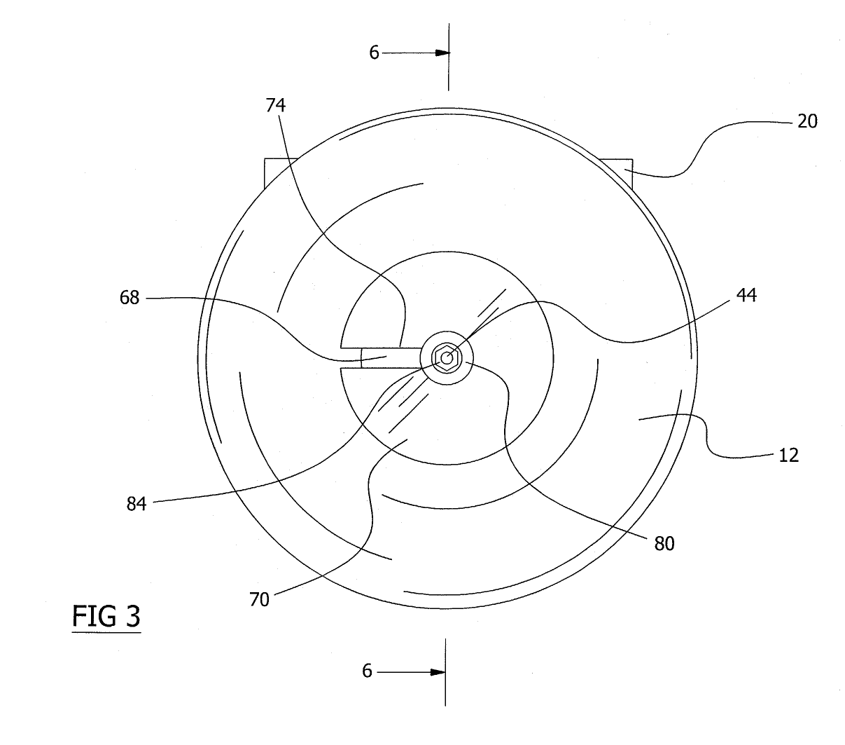

Turning now descriptively to the drawings, in which similar reference characters denote similar elements throughout the several views, FIGS. 1 through 9 illustrate a slitter knife system 10, which comprises a main housing 20, a chuck housing 30 movably positioned within the main housing 20, a plunger member 40 movably positioned within the chuck housing 30, an arbor member 60 rotatably attached about a portion of the chuck housing 30 for receiving an upper knife 12, a clamp member 70 positioned adjacent the upper knife 12, and an outer bearing 80 attached to a distal portion of the plunger member 40. Utilizing a source of air pressure, a user is able to draw the plunger member 40 inwardly so that the outer bearing 80 forces the clamp member 70 tightly against the upper knife 12. When replacement of the upper knife 12 is required, the user releases the air pressure and a spring engaging the plunger member 40 forces the same outwardly to allow for removal of the clamp member 70 thereby providing unobstructed access to the upper knife 12.

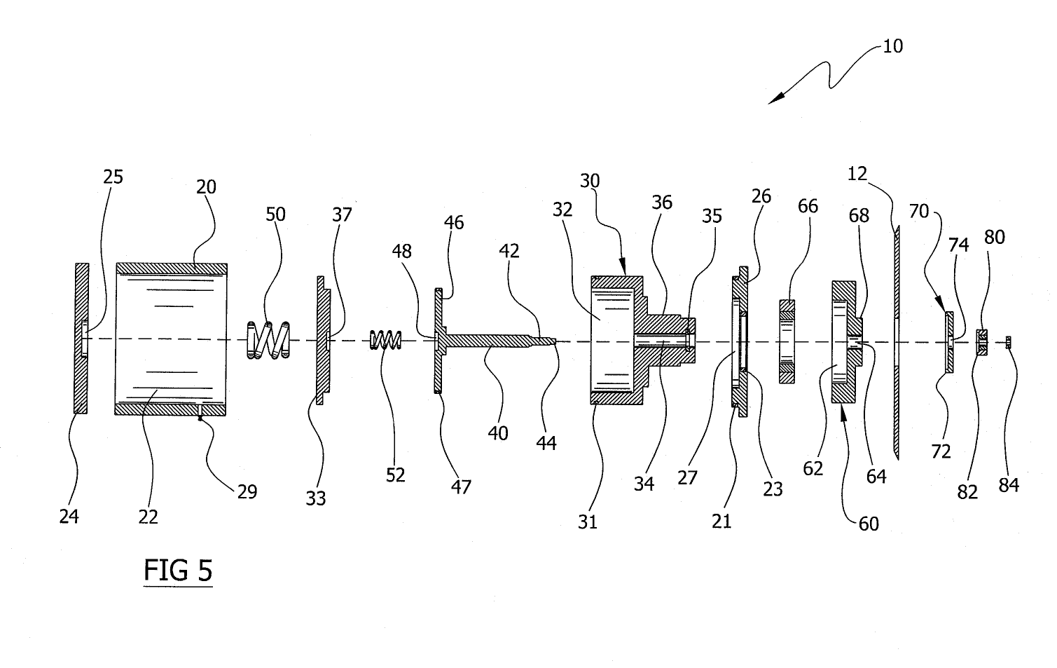

As shown in FIGS. 1 and 5 of the drawings, the main housing 20 has a main interior 22 that slidably receives the chuck housing 30. The interior portion of the main housing 20 is preferably comprised of a circular cross sectional area as best illustrated in FIG. 1a of the drawings. The main housing 20 may have various exterior shapes and structures. The main housing 20 is attached to a carriage frame structure that is attached within the slitter machine similar to conventional slitter knife units. The carriage frame structure may be attached in various manners to the slitter machine which are widely utilized within the slitter machine industry. An example of a suitable carriage frame structure is illustrated in U.S. Pat. No. 5,083,489 and is hereby incorporated by reference. Various other carriage frame structures may be utilized to support the main housing 20 as can be appreciated by one skilled in the art.

As shown in FIG. 1a of the drawings, a first cap member 24 is sealably attached to a first end of the main housing 20 for enclosing the main interior 22 of the main housing 20. The first cap member 24 includes a first cavity 25 for receiving the first spring 50, wherein the first spring 50 is compressed between the first cap member 24 and the chuck cap member 33 for forcing the chuck housing 30 outwardly from within the main housing 20.

As shown in FIGS. 1A and 5 of the drawings, a main nipple 29 is fluidly connected within the main housing 20 for delivering pressurized air to within the main housing 20 to force the chuck housing 30 inwardly. A tube or other structure capable of transferring pressurized air to the main interior 22 is fluidly connected to the main nipple 29.

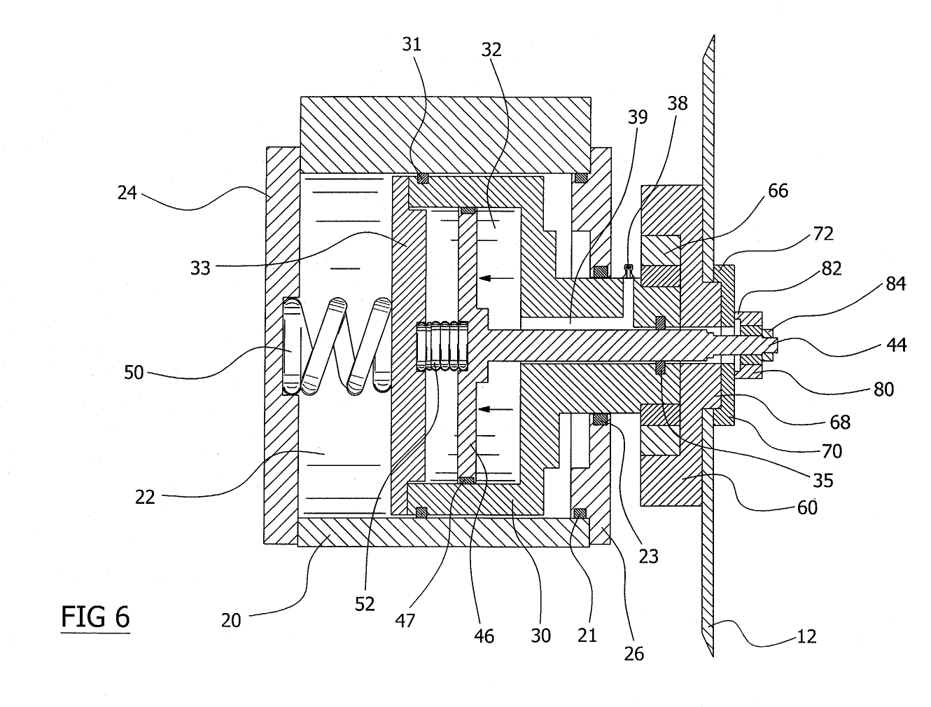

A second cap member 25 sealably connects to the second end of the main housing 20 and sealably receives a portion of the chuck housing 30 thereby creating an air cylinder structure utilizing the chuck housing 30. A first seal 21 is positioned upon an inner portion of the second cap member 25 to seal with the main interior 22 of the main housing 20 as best illustrated in FIG. 6 of the drawings. A second seal 23 is positioned within the main opening 27 of the second cap member 25 for sealing about the extended portion 36 of the chuck housing 30 as best illustrated in FIGS. 5 and 6 of the drawings. Pressurized air entering the main interior 22 of the main housing 20 forces the chuck housing 30 inwardly thereby causing the upper knife 12 to engage a lower knife and compressing the first spring 50. When the pressurized air is released from the main interior 22, the first spring 50 forces the chuck housing 30 outwardly from the main housing 20 so that the upper knife 12 is positioned away from the lower knife of the slitter machine.

As best shown in FIGS. 1A and 5 of the drawings, the chuck housing 30 includes a chuck interior 32 that slidably receives the plunger member 40. The chuck housing 30 has a main body that snugly fits within the main interior 22 of the main housing 20. An outer seal 31 within the chuck housing 30 forms a seal between the chuck housing 30 and the main interior 22 of the main housing 20 thereby allowing pressurized air entered through the main nipple 29 to force the chuck housing 30 inwardly. The passage fluidly connected to the main nipple 29 has an exit port within the main interior 22 on the outside of the outer seal 31 to facilitate the proper directional movement of the chuck housing 30 upon application of pressurized air to the main interior 22.

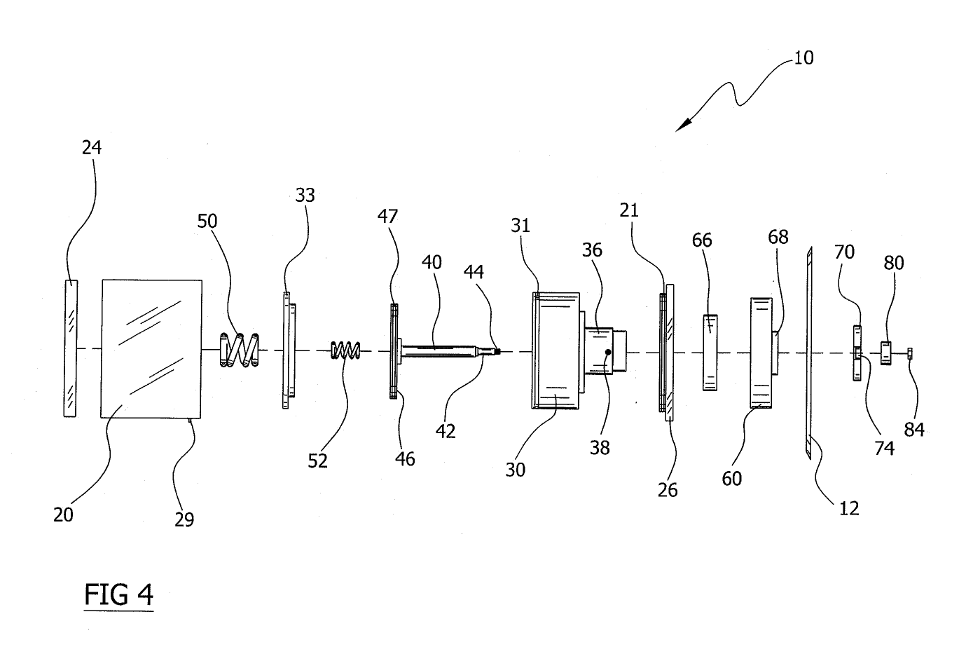

As best shown in FIGS. 4 and 5 of the drawings, the chuck housing 30 has an extended portion 36 that extends from the main body that extends through the main opening 27 within the second cap member 25. The extended portion 36 sealably extends through the main opening 27 with the second seal 23 within the second cap member 25 forming the desired seal about the extended portion 36, thereby forming an enclosed cavity within the main housing 20 (i.e. the main interior 22).

As best shown in FIG. 5 of the drawings, a center bore 34 extends through the extended portion 36 of the chuck housing 30 for slidably receiving the plunger member 40. As shown in FIG. 6 of the drawings, an inner seal 35 positioned within the center bore 34 of the extended portion 36 forms a seal about the shaft portion of the plunger member 40. A chuck cap member 33 is sealably attached to the chuck housing 30 to enclose the chuck interior 32 as shown in FIGS. 5 and through 8 of the drawings. The chuck cap member 33 preferably includes a chuck cavity 37 for receiving a distal end of the second spring 52 as shown in FIG. 1A of the drawings.

As shown in FIGS. 1A, 4, 5, 6, 7 and 8 of the drawings, the plunger member 40 is slidably positioned within the chuck interior 32. An elongate shaft of the plunger member 40 slidably extends through the center bore 34 within the chuck housing 30 and a broad portion 46 of the plunger member 40 is slidably positioned within the chuck interior 32. A plunger seal 47 is attached about the perimeter of the broad portion 46 for sealing within the chuck interior 32 as illustrated in FIGS. 6 through 8 of the drawings. The broad portion 46 of the plunger member 40 includes a plunger cavity 48 centrally positioned within opposite of the elongate shaft for receiving the opposing distal end of the second spring 52 as shown in FIGS. 5 through 8 of the drawings.

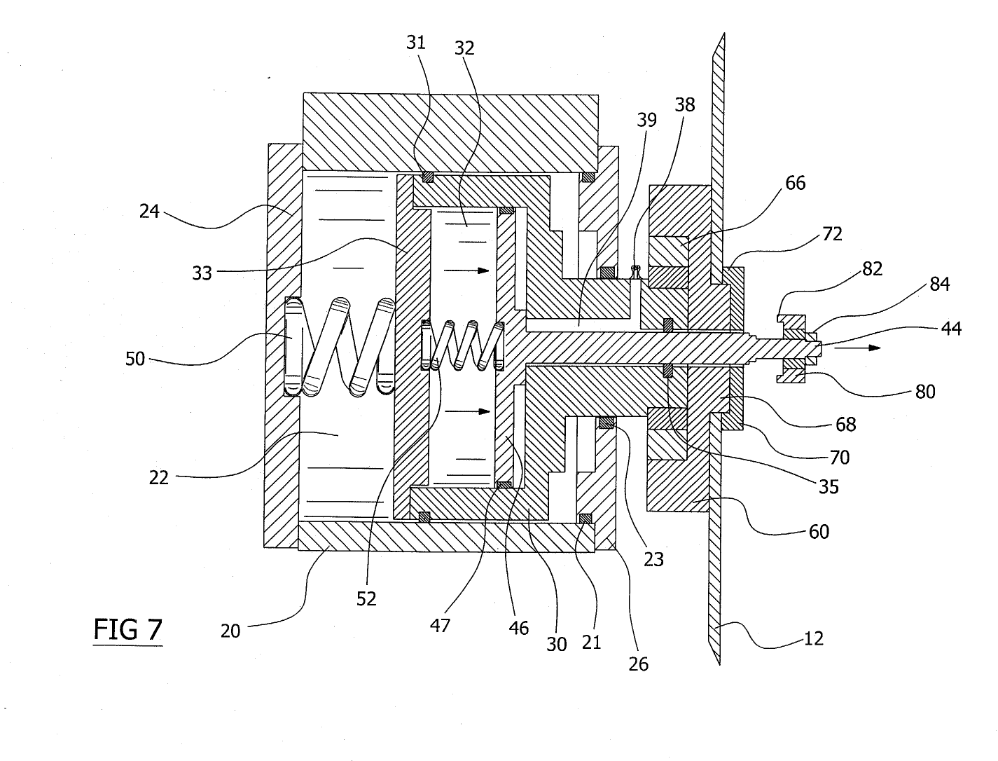

The second spring 52 forces the plunger member 40 outwardly from within the chuck housing 30 as illustrated in FIG. 7 of the drawings. When air pressure is applied through the second nipple 38 within the chuck housing 30 towards the chuck interior 32, the plunger member 40 is forced inwardly thereby compressing the second spring 52. A first passage 39 preferably is fluidly connected to the second nipple 38 that extends from the second nipple 38 to the chuck interior 32 to provide air pressure upon the plunger member 40 thereby forcing the plunger member 40 inwardly.

A first distal portion 42 and a second distal portion 44 extend from the extended portion 36 of the chuck housing 30 as illustrated in FIGS. 6 through 8 of the drawings. The second distal portion 44 is preferably a threaded portion for threadably receiving a fastening nut 84 that retains the outer bearing 80 adjacent the clamp member 70 during usage.

As shown in FIGS. 6 through 8 of the drawings, an arbor member 60 is rotatably positioned about the distal portion of the chuck housing 30 extended portion 36. An inner bearing 66 is preferably positioned about the distal portion of the extended portion 36 and received within an arbor cavity 62 of the arbor member 60. An arbor bore 64 extends centrally through the arbor member 60 for allowing the elongate shaft of the plunger member 40 to freely extend through. The arbor bore 64 has a diameter sufficient so as to not engage the elongate shaft of the plunger member 40 during rotation of the arbor member 60.

The arbor member 60 includes a receiver portion 68 that extends a finite distance from the main portion of the arbor member 60 as shown in FIGS. 1B, 4 and 5 of the drawings. The receiver portion 68 has an outer diameter that snugly receives the upper knife 12 as shown in FIGS. 6 through 8 of the drawings. The receiver portion 68 preferably extends a distance greater than a thickness of the upper knife 12 for receiving and aligning the clamp member 70 as shown in FIGS. 6 through 8 of the drawings.

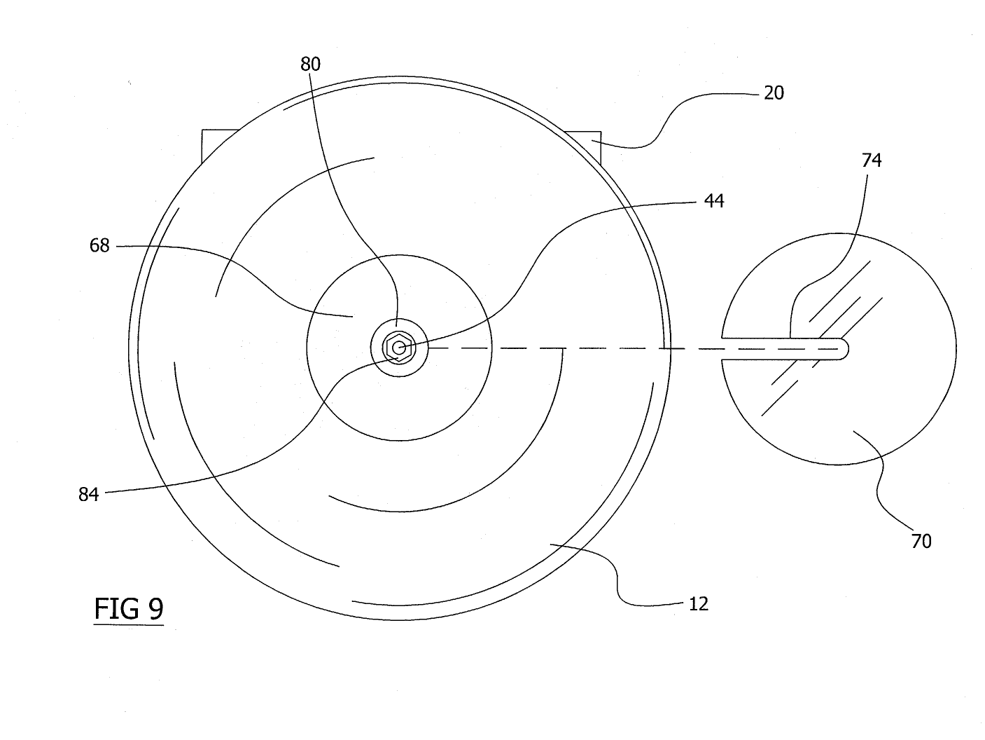

As shown in FIGS. 4 through 8 of the drawings, a clamp member 70 is provided that snugly fits about the receiver portion 68 of the arbor member 60 for tightly securing the upper knife 12 upon the arbor member 60. The clamp member 70 includes an inner lip 72 that snugly surrounds the receiver portion 68 and that engages the body of the upper knife 12 in a secure manner when the plunger member 40 is forced inwardly. The clamp member 70 includes a slot 74 that extends from the outer perimeter to the inner portion for allowing the clamp member 70 to be easily removed and positioned about the shaft of the plunger member 40 as shown in FIG. 9 of the drawings. The slot 74 has a width greater than the outer diameter of the shaft of the plunger member 40 to prevent engagement with the plunger member 40.

As further shown in FIGS. 4 through 8 of the drawings, an outer bearing 80 is pressed upon the first distal portion 42 of the plunger member 40. The outer bearing 80 has a lip portion 82 extending from an outer portion of the outer bearing 80 that engages the clamp member 70 as shown in FIG. 6 of the drawings. The fastening nut 84 is threadably secured upon the second distal portion 44 of the plunger member 40 such that the fastening nut 84 engages an inner portion of the outer bearing 80 without interfering with the rotation of the outer portion of the outer bearing 80 that provides for free rotation of the arbor member 60, upper knife 12 and clamp member 70.

A conventional control system is utilized to control the input of pressurized air into the main interior 22 and the chuck interior 32. The conventional control system may be comprised of manual switches to allow for the operation thereof manually, or an automatic system that performs the desired control steps.

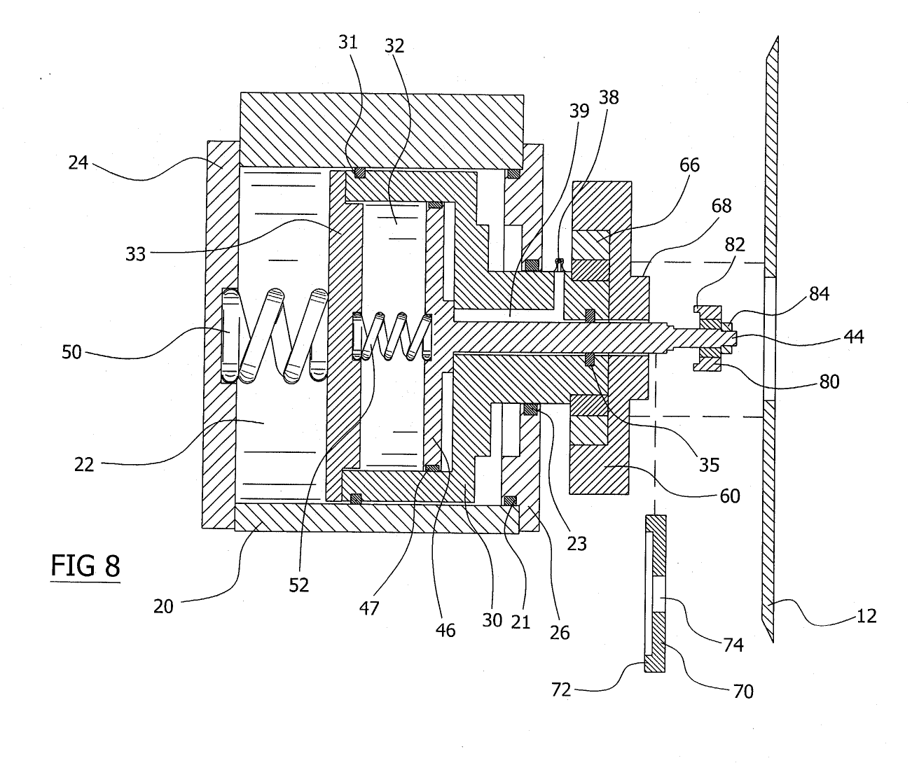

In the initial state of the present invention illustrated in FIG. 8 of the drawings, the first spring 50 and the second spring 52 are fully extended with the chuck housing 30 fully extended from the main housing 20 and the plunger member 40 fully extended from the chuck housing 30. With the plunger member 40 fully extended, the user is able to position the upper knife 12 upon the receiver portion 68 of the arbor member 60 as shown in FIG. 7 of the drawings. The user then positions the clamp member 70 upon receiver portion 68 adjacent to the upper knife 12 with the slot 74 fitting about the shaft of the plunger member 40 as further shown in FIG. 7 of the drawings. The user ensures that the clamp member 70 is properly aligned upon the arbor member 60 thereby ensuring that the upper knife 12 will be securely retained upon the arbor member 60. The user then operates the control system to open a valve that allows pressurized air into the second nipple 38 that flows through the first passage 39 into the chuck interior 32 thereby causing the plunger member 40 to be forced inwardly thereby compressing the second spring 52 as shown in FIG. 6 of the drawings. As the plunger member 40 is forced inwardly, the lip portion 82 of the outer bearing 80 engages the clamp member 70 thereby tightly retaining the upper knife 12 upon the arbor member 60. The air pressure is maintained through the second nipple 38 to ensure that the upper knife 12 does not become removed from the arbor member 60. After the upper knife 12 has been properly secured to the arbor member 60, the user then manipulates the control system to open a valve that applies air pressure within the main interior 22 which forces the entire chuck housing 30 inwardly which results in the upper knife 12 simultaneously moved inwardly against a lower knife and compressing the first spring 50. The carriage structure (not shown) attached to the main housing and the slitter machine would also allow for the raising/lowering of the main housing 20 which in turn raises/lowers the upper knife 12.

When the upper knife 12 becomes worn, the user removes the air pressure to the main interior 22 thereby allowing the first spring 50 to force the chuck housing 30 outwardly which removes the upper knife 12 from the lower knife. The user then removes the air pressure to the chuck interior 32 thereby allowing the second spring 52 to force the plunger member 40 outwardly which removes the outer bearing 80 from the clamp member 70 as shown in FIG. 7 of the drawings. After the outer bearing 80 has been removed from the clamp member 70, the user is then able to remove the clamp member 70 from the arbor member 60 by allowing the shaft of the plunger member 40 to freely pass through the slot 74 within the clamp member 70. After the clamp member 70 has been removed, the user then removes the upper knife 12 from the receiver portion 68 of the arbor member 60. The user then replaces the upper knife 12 with a second upper knife 12 by following the process stated previously.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A slitter knife system operational within a slitter machine, comprising:
a main housing having a main interior;
a chuck housing positioned within said main housing, wherein said chuck housing has a chuck interior and a center bore extending from said chuck interior;
a plunger member having a shaft portion and a broad portion, wherein said shaft portion slidably extends through said center bore and said broad portion is slidably positioned within said chuck interior;
a spring positioned within said chuck housing and between a wall of said chuck housing and said plunger member thereby forcing said plunger member into an outward position;
a first passage extending into said chuck housing to said chuck interior for providing air pressure to said chuck interior thereby forcing said plunger member into an inward position;
an arbor member rotatably positioned about an extended portion of said chuck housing for receiving an upper knife;
a clamp member having a slot positionable upon said arbor member adjacent said upper knife; and
an outer bearing attached to a distal portion of said shaft portion of said plunger member in selective engagement with said clamp member for retaining said clamp member adjacent said upper knife when said plunger member is within said inward position.

2. The slitter knife system of claim 1, wherein said arbor member includes a receiver portion extending from a main body of said arbor member for receiving said upper knife.

3. The slitter knife system of claim 2, wherein said clamp member includes an inner lip within a perimeter thereof extending towards and engaging said upper knife.

4. The slitter knife system of claim 3, wherein said receiver portion extends a distance greater than a width of said upper knife for snugly receiving said clamp member.

5. The slitter knife system of claim 1, wherein said slot within said clamp member has a width greater than an outer diameter of said shaft portion.

6. The slitter knife system of claim 1, wherein said outer bearing includes an outer portion and an inner portion, where said outer portion includes a lip portion that engages said clamp member.

7. The slitter knife system of claim 6, including a fastening nut threadably attached to said distal portion of said shaft portion adjacent said inner portion of said outer bearing.

8. The slitter knife system of claim 1, wherein said broad portion of said plunger shaft includes a plunger cavity centrally positioned for receiving a distal end of said spring.

9. The slitter knife system of claim 8, wherein said chuck housing includes a chuck cap member having a chuck cavity centrally positioned for receiving an opposing distal end of said spring.

10. The slitter knife system of claim 1, wherein said broad portion includes a plunger seal within an outer perimeter thereof for sealing within said chuck cavity.

11. A slitter knife system operational within a slitter machine, comprising:
a main housing having a main interior;
a chuck housing positioned within said main housing, wherein said chuck housing has a chuck interior and a center bore extending from said chuck interior;
a plunger member having a shaft portion and a broad portion, wherein said shaft portion slidably extends through said center bore and said broad portion is slidably positioned within said chuck interior;
a spring positioned within said chuck housing and between a wall of said chuck housing and said plunger member thereby forcing said plunger member into an outward position;
a first passage extending into said chuck housing to said chuck interior for providing air pressure to said chuck interior thereby forcing said plunger member into an inward position;
an arbor member rotatably positioned about an extended portion of said chuck housing for receiving an upper knife;
a clamp member having a slot positionable upon said arbor member adjacent said upper knife; and
an engaging structure attached to a distal portion of said shaft portion of said plunger member for selectively engaging said clamp member.

12. The slitter knife system of claim 11, wherein said arbor member includes a receiver portion extending from a main body of said arbor member for receiving said upper knife.

13. The slitter knife system of claim 12, wherein said clamp member includes an inner lip within a perimeter thereof extending towards and engaging said upper knife.

14. The slitter knife system of claim 13, wherein said receiver portion extends a distance greater than a width of said upper knife for snugly receiving said clamp member.

15. The slitter knife system of claim 11, wherein said slot within said clamp member has a width greater than an outer diameter of said shaft portion.

16. The slitter knife system of claim 11, wherein said engaging structure includes an outer bearing having an outer portion and an inner portion, where said outer portion includes a lip portion that engages said clamp member.

17. The slitter knife system of claim 16, including a fastening nut threadably attached to said distal portion of said shaft portion adjacent said inner portion of said outer bearing.

18. The slitter knife system of claim 11, wherein said broad portion of said plunger shaft includes a plunger cavity centrally positioned for receiving a distal end of said spring.

19. The slitter knife system of claim 18, wherein said chuck housing includes a chuck cap member having a chuck cavity centrally positioned for receiving an opposing distal end of said spring.

20. A method of operating a slitter knife unit upon a slitter machine including a chuck housing positioned within a main housing, wherein said chuck housing has a chuck interior and a center bore extending from said chuck interior, a plunger member having a shaft portion and a broad portion, wherein said shaft portion slidably extends through said center bore and said broad portion is slidably positioned within said chuck interior, a spring positioned within said chuck housing and between a wall of said chuck housing and said plunger member thereby forcing said plunger member into an outward position, a first passage extending into said chuck housing to said chuck interior for providing air pressure to said chuck interior thereby forcing said plunger member into an inward position, an arbor member rotatably positioned about an extended portion of said chuck housing for receiving an upper knife, a clamp member having a slot positionable upon said arbor member adjacent said upper knife, and an outer bearing attached to a distal portion of said shaft portion of said plunger member in selective engagement with said clamp member for retaining said clamp member adjacent said upper knife when said plunger member is within said inward position, said method comprising the steps of:
(a) positioning an upper knife upon said arbor member;
(b) positioning said clamp member upon said arbor member adjacent to said upper knife; and
(c) applying air pressure to said first passage thereby forcing said plunger member inwardly until said outer bearing tightly engages said clamp member against said upper knife.
